(19) United States
(12) Patent Application Publication
(10) Pub. No.: US 2024/0361004 A1
(43) Pub. Date: Oct. 31, 2024

(54) OIL PAN BRACKET STRUCTURE AND GRILL

(71) Applicant: NINGBO AGSUN PRODUCTS,INC., CIXI (CN)

(72) Inventors: Jinsheng Wu, CIXI (CN); Binhang Sun, CIXI (CN); Xuefei Mao, CIXI (CN); Xianghua Liu, CIXI (CN); Junye Mi, CIXI (CN)

(21) Appl. No.: 18/765,469

(22) Filed: Jul. 8, 2024

(30) Foreign Application Priority Data
Apr. 30, 2024 (CN) 202420943470.0

(51) Int. Cl. F24C 15/14

(52) U.S. Cl. CPC F24C 15/14

(57) ABSTRACT

The present invention discloses an oil pan bracket structure including a support, the support is slidably connected to a bracket, the bracket has an oil pan mounted thereon to cause the oil pan to be drawably mounted on the support along with the bracket, and a sliding guide structure is provided between the support and the bracket. The present invention also discloses a grill having the oil pan bracket structure. The present invention allows the oil pan not to be detached from a grill even after being drawn to an extreme position along with the bracket.

### TECHNICAL FIELD

The present invention pertains to the technical field of barbecue equipment, and particularly pertains to an oil pan bracket structure and a grill.

### BACKGROUND

At present, a grill is usually provided with an oil pan on a bottom thereof. In the case of a movable oil pan, folded edges at both sides of the oil pan are usually in contact with a guide surface of a fixed support to produce frictional sliding to realize drawing movement of the oil pan. For example, U.S. Pat. No. 11,172,780 B2 discloses a composite environmental-friendly grill, where a grill body thereof is movably provided with a grease pan on a bottom thereof, and the grease pan can be drawn back and forth, but the grease pan is easily detached due to the lack of a limit structure, and drawing is relatively laborious.

### SUMMARY

The purpose of the present invention is to provide an oil pan bracket structure designed to solve the above-mentioned technical deficiencies.

The present invention provides an oil pan bracket structure including a support, where the support is slidably connected to a bracket, the bracket has an oil pan mounted thereon to cause the oil pan to be drawably mounted on the support along with the bracket, and a sliding guide structure is provided between the support and the bracket.

The sliding guide structure includes a guide groove and a guide post.

The guide groove is arranged on the support and the guide post is arranged on the bracket, or the guide post is arranged on the support and the guide groove is arranged on the bracket.

The guide groove is arranged along a sliding direction of the bracket to form a guide groove with an elongated structure, and the guide post is placed in the guide groove.

In another aspect, an oil pan bracket structure, includes:
a support slidably connected to a bracket, where the bracket has an oil pan mounted thereon to cause the oil pan to perform a sliding movement along with the bracket on the support; and
a sliding guide structure provided between the support and the bracket to limit the sliding movement of the bracket along a length direction of the support;

When the bracket slides in a first direction so that a distance between a front side portion of the bracket and a front side portion of the support is L1, a first limit portion of the bracket and a second limit portion on the support abut against each other.

When the bracket slides in a second direction so that the distance between the front side portion of the bracket and the front side portion of the support is L2, a third limit portion of the bracket and a fourth limit portion on the support abut against each other.

In another aspect, a grill includes a grill body and the oil pan bracket structure as described above, where the grill body is provided with grilling nets and burner switches therein, a plurality of the grilling nets are sequentially arranged along an arrangement direction of oil pans, the grill body is provided with a first oil guide plate, two second oil guide plates and a third oil guide plate between the burner switches and the oil pans, and the first oil guide plate is located directly above the oil pan.

The two second oil guide plates are respectively located at both sides of the first oil guide plate, one end of the two second oil guide plates is connected to the grill body, and the other end of the two second oil guide plates is suspended and inclined downward.

The third oil guide plate is located between two oil pans and is located below the first oil guide plate, and the third oil guide plate is arranged to have a convex middle portion with both sides inclined downward towards corresponding oil pans respectively.

Each of the supports is connected to bottoms of the two second oil guide plates respectively.

The present invention has the following technical effects: a grill body is provided with supports extending in a front-rear direction on the bottom thereof, a bracket is slidably connected between the two supports, an oil pan is detachably provided on the bracket, and the oil pan is drawn along with the bracket to facilitate replacement and cleaning of the oil pan; a roller is provided on the support, causing the bracket to slide along the supports in a labor-saving manner; a clamping groove is provided on the bracket, when the bracket is completely closed, the roller is just snapped into the clamping groove to form locking, so that the bracket cannot be easily drawn; when the bracket needs to be drawn, the bracket can be drawn again only by applying a force to unlock the roller and the clamping groove; a guide post is further provided on the bracket, and a guide groove in sliding fit with the guide post is correspondingly provided on the bracket to guide a reciprocal sliding of the bracket relative to the support; and since the guide post is inserted into the guide groove, a limit is formed between the guide groove and the guide post, so that the bracket will not be detached from the support after being drawn to an extreme position.

### BRIEF DESCRIPTION OF THE DRAWINGS

FIG. 1 is a bottom view of an overall structure of a grill;

FIG. 2 is a top view of an assembly structure of a support, a bracket and an oil pan;

FIG. 3 is a bottom view of the assembly structure of the support, the bracket and the oil pan;

FIG. 4 is an enlarged view of A in FIG. 3;

FIG. 5 is a structural exploded view of the support, the bracket and the oil pan;

FIG. 6 is an exploded view of the overall structure of the grill;

FIG. 7 is a cross-sectional view of the overall structure of the grill;

FIG. 8 is a structural diagram when a distance between a front side portion of the bracket and a front side portion of the support is L1; and

FIG. 9 is a structural diagram when the distance between the front side portion of the bracket and the front side portion of the support is L2.

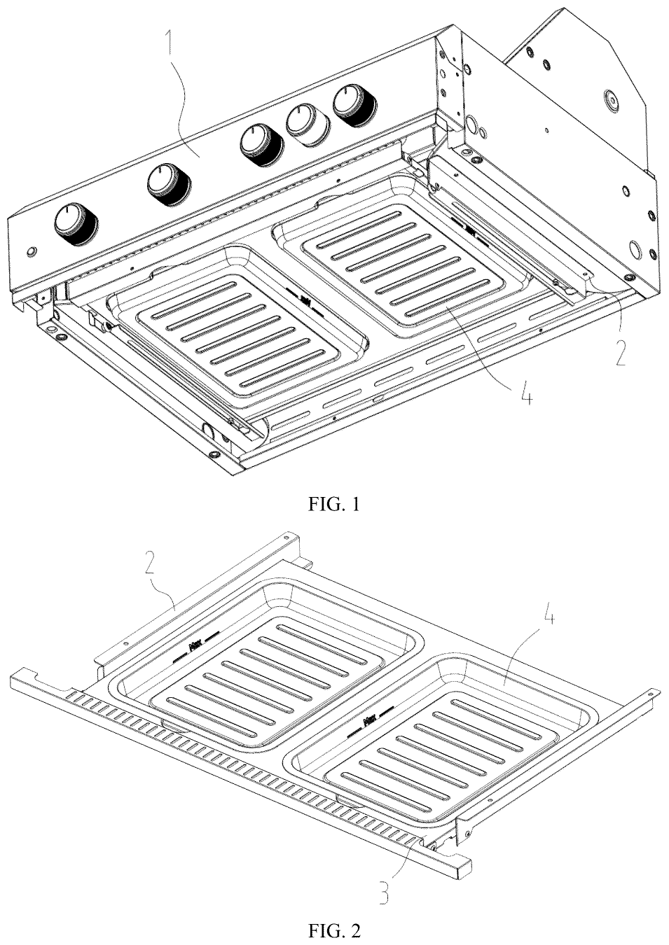

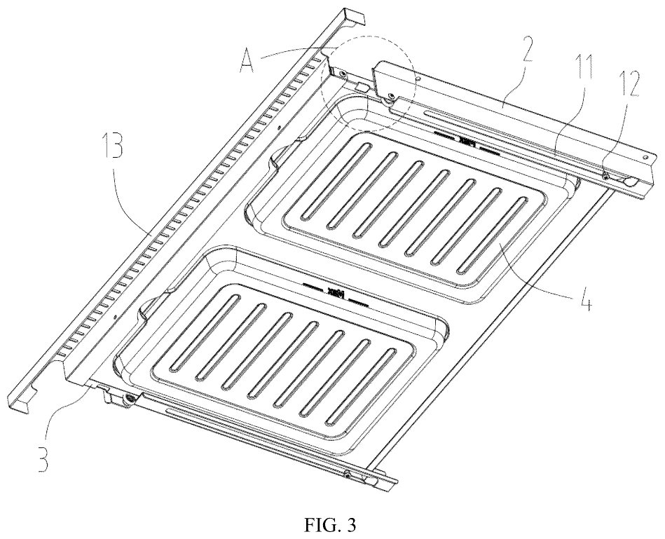

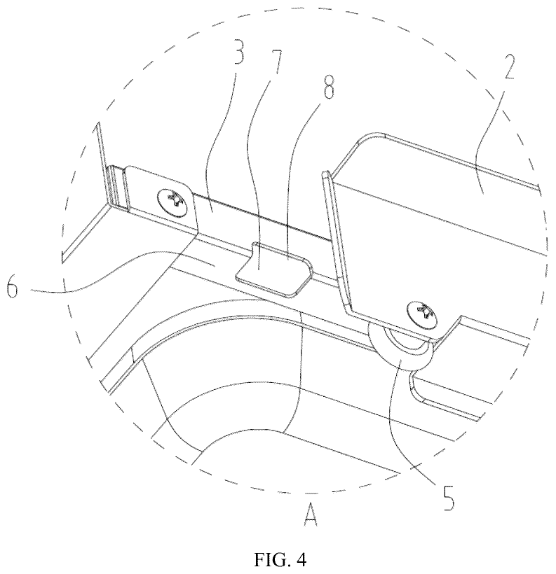

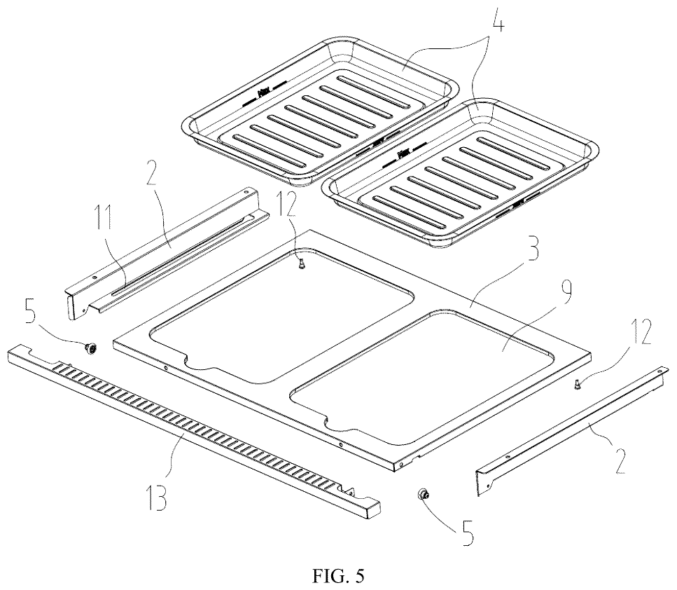

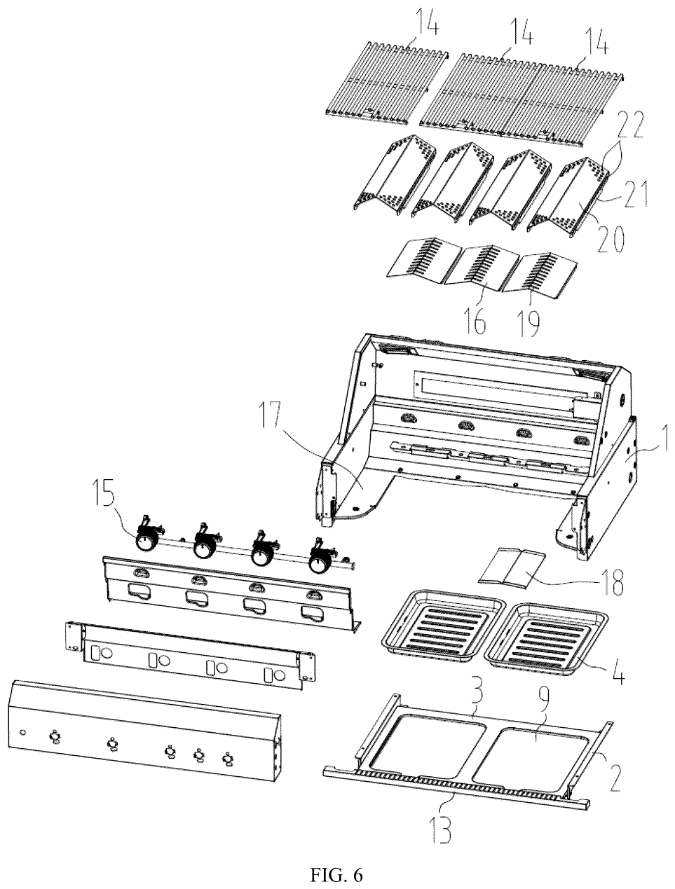

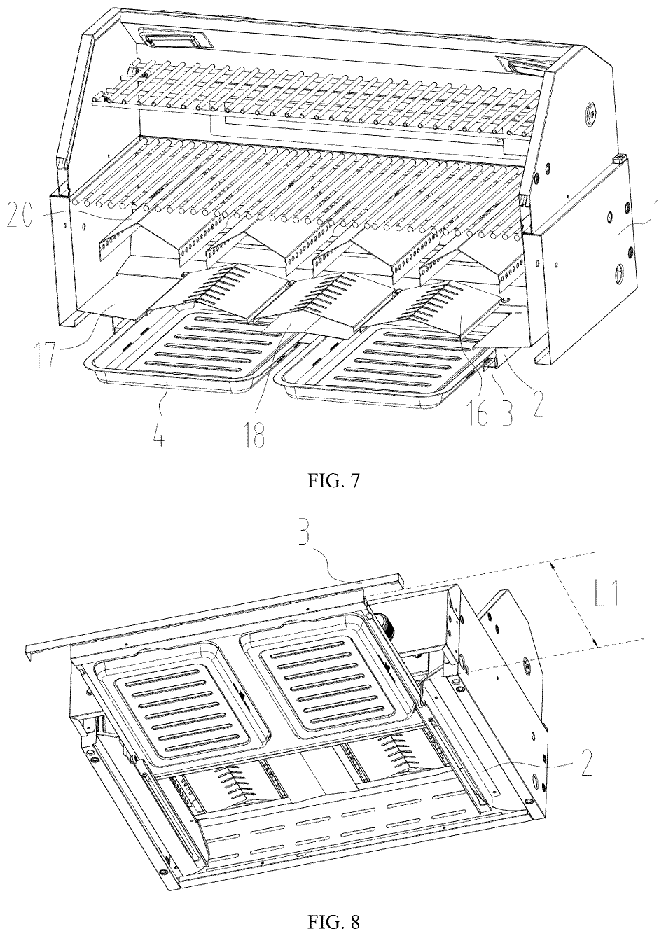

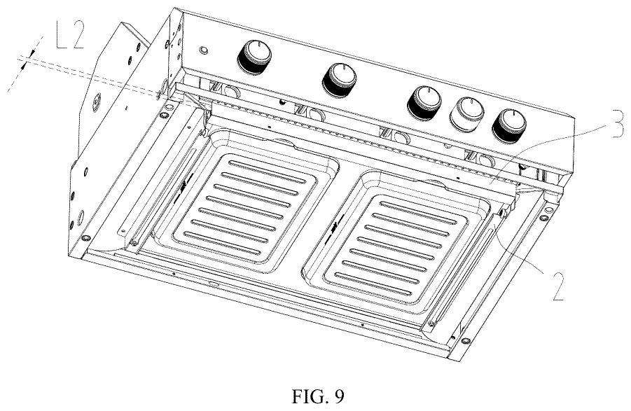

Reference numerals in the drawings: 1. grill body; 2. support; 3. bracket; 4. oil pan; 5. roller; 6. guide surface; 7. clamping groove; 8. withdrawal groove; 9. mounting groove; 11. guide groove; 12. guide post; 13. handle; 14. grilling net; 15. burner switch; 16. first oil guide plate; 17. second oil guide plate; 18. third oil guide plate; 19. first air hole; 20. temperature equalization plate; 21. bending portion; and 22. second air hole.

### DESCRIPTION OF THE EMBODIMENTS

The technical solutions in the embodiments of the present invention will be clearly and completely described below in conjunction with the accompanying drawings in the embodiments of the present invention. Obviously, the embodiments described are only part but not all of the embodiments of the present invention. All other embodiments obtained by those of ordinary skill in the art based on the embodiments of the present invention fall within the scope of the present invention.

The present invention provides an oil pan bracket structure which includes supports 2, the supports 2 are two in number, a bracket 3 is provided between the two supports 2, that is to say, the two supports 2 are located at both sides of the bracket 3 and support the bracket 3, an oil pan 4 is provided on the bracket 3, the bracket 3 is of a plate-shaped structure, a mounting groove 9 is provided in a center thereof, and the oil pan 4 is embedded in the mounting groove 9, so that the oil pan 4 is detachably mounted on the bracket 3. In the present embodiment, the mounting grooves 9 are two in number, the two mounting grooves 9 are arranged in parallel, the oil pans 4 are correspondingly also two in number, and each of the oil pans 4 is respectively embedded in each of the two mounting grooves 9, so that the two oil pans 4 are arranged in parallel in the mounting grooves 9. Of course, a plurality of mounting grooves 9 may be provided, and correspondingly, more than two oil pans 4 may be provided, so that an entire underside of a grilling net can be covered.

Each of the supports 2 is provided with a roller 5, the rollers 5 may be one or more in number, and multiple rollers 5 are linearly distributed along a front-rear direction of the supports 2. In the present embodiment, the roller 5 on each of the supports 2 is one in number; the bracket 3 is correspondingly provided with a guide surface 6 forming a sliding fit with the roller 5, and the guide surface 6 is a horizontal plane, so that the bracket 3 can slide reciprocally along a length direction of the supports 2, and finally the bracket 3 can be drawn along the supports 2.

A clamping groove 7 is provided on the guide surface 6, and when the clamping groove 7 slides with the bracket 3 to a preset position, the roller 5 is embedded in the clamping groove 7 to form a limit. In the present embodiment, when the bracket 3 is drawn, the guide surface 6 slides along the roller 5; when the bracket 3 is closed, the guide surface 6 slides along the roller 5 until the roller 5 is just snapped into the clamping groove 7 to lock the bracket, so that the bracket 3 cannot be easily drawn, and when the bracket 3 needs to be drawn again, it is only necessary to use a force or gently lift the bracket 3 so that the roller 5 is detached from the clamping groove 7 for unlocking. It should be noted that the clamping groove 7 has a rectangular shape, a length direction of the clamping groove 7 coincides with a sliding direction of the bracket 3, and length and width dimensions of the clamping groove 7 are greater than an outer diameter dimension of the roller 5, so that the roller 5 can be completely snapped into the clamping groove 7, so that the locking is secure.

Further, in the present embodiment, a side edge of the bracket 3 is bent to form the guide surface 6, a side surface of the guide surface 6 is a bending surface, a withdrawal groove 8 communicating with the clamping groove 7 is provided on the bending surface, a length dimension of the withdrawal groove 8 is the same as that of the clamping groove 7, so that the roller 5 can move laterally out of the withdrawal groove, that is to say, the bracket 3 can be manually moved laterally to unlock the clamping groove 7 from the roller 5 to facilitate drawing.

In addition, opposite side surfaces of the two supports 2 are respectively provided with a supporting surface, the supporting surface is a horizontal plane, bottom surfaces of the both sides of the bracket 3 are the guide surfaces 6, and the guide surfaces 6 contact the supporting surface and slide along the supporting surface. That is to say, the guide surface 6 and the roller 5 are in contact for sliding, and then limited by the clamping groove 7 and the roller 5.

A sliding guide structure is provided between the support 2 and the bracket 3, the sliding guide structure comprises a guide groove 11 and a guide post 12, the guide groove 11 is arranged on the supporting surface and extends along a sliding direction to form an elongated structure, a guide post 12 is provided on the guide surface 6 of the bracket 3, one end of the guide post 12 is fixed on the guide surface 6, and the other end thereof is inserted into the guide groove 11; when the bracket 3 slides, the guide post 12 slides reciprocally within the guide groove 11 and along the guide groove 11, that is to say, a sliding guide is formed between the guide post 12 and the guide groove 11; or the guide groove 11 is arranged on the guide surface 6 of the bracket 3, and the guide post 12 is fixed on the supporting surface of the support 2, and the guide groove 11 and the guide post 12 fit with each other to form a sliding guide.

Further, the guide post 12 may be a step screw or a step bolt, a rod body thereof passes through the guide groove 11 and is fixed on the bracket 3, and a head portion thereof forms a limit with the guide surface 6 to the guide groove 11, so that when the bracket 3 slides along the supports 2, the guide post 12 can slide along the guide groove 11 to guide and stabilize sliding of the bracket 3.

A handle 13 is provided on a front of the bracket 3, the handle 13 extends in a width direction of the bracket 3, and is fixed on the bracket 3 by a fastener to facilitate manual drawing and closing of the bracket 3.

The guide post 12 is arranged on the bracket 3, the guide post 12 serves as a first limit portion of the bracket 3, and one end of the guide groove 11 close to a front side portion of the bracket 3 serves as a second limit portion of the support 2, or the guide post 12 is arranged on the support 2, the guide groove 11 is arranged on the bracket 3, the guide post 12 serves as a second limit portion of the support 2, and one end of the guide groove 11 close to the front side portion of the bracket 3 serves as a first limit portion of the bracket 3; and the clamping groove 7 is provided on the guide surface 6, the clamping groove 7 serves as a third limit portion, and the roller 5 serves as a fourth limit portion, and when the clamping groove 7 moves along with sliding of the bracket 3, the roller 5 is embedded in the clamping groove 7 to form a limit.

That is, when the bracket 3 slides in a first direction so that a distance between the front side portion of the bracket 3 and a front side portion of the support 2 is L1, the first limit portion of the bracket 3 and the second limit portion on the support 2 abut against each other.

When the bracket 3 slides in a second direction so that the distance between the front side portion of the bracket 3 and the front side portion of the support 2 is L2, the third limit portion of the bracket 3 and the fourth limit portion on the support 2 abut against each other. As shown in FIG. 2, that is, when the distance is L2, the oil pan 4 is in a closed state, whereas when the distance is L1, the oil pan 4 is in a drawn-away state.

An embodiment of the present invention also provides a grill which includes a grill body 1, where there are two supports 2, which are fixed on a bottom surface of the grill body 1 parallel to each other along a front-rear directions; and grilling nets 14 and burner switches 15 are provided within the grill body 1, and multiple grilling nets 14 are sequentially arranged along an arrangement direction of oil pans 4. In the present embodiment, the grilling nets 14 are three in number; the grill body 1 is provided with a first oil guide plate 16, a second oil guide plate 17 and a third oil guide plate 18 between the burner switches 15 and the oil pans 4; and the first oil guide plate 16 is located directly above the oil pan 4. In the present embodiment, the first oil guide plates 16 are three in number, the three first oil guide plates 16 are sequentially arranged along the arrangement direction of the oil pans 4, front and rear ends of the three first oil guide plates 16 are all connected to an inner wall of the grill body 1, each of the first oil guide plates 16 is in a curved structure with a convex middle portion and both sides inclined downward, a first air hole 19 is provided on a surface of the convex middle portion of each of the first oil guide plate 16, part of hot air flows upward after passing through the first air hole 19 to increase air flow, or waste oil can fall directly through the first air hole 19 into the oil pan 4, and a certain gap is left between the three first oil guide plates 16 to increase the flow of air from bottom to top; and the first air hole 19 is in the shape of a long strip and is distributed in the middle portion of the first oil guide plate 16 along a bending line, so that the air forms a lateral three-dimensional distribution, facilitating rapid and uniform distribution of heat within the grill body 1.

The second oil guide plates 17 are two in number, the two second oil guide plates 17 are located at both sides of the first oil guide plate 16, one end of the second oil guide plate 17 is connected to the inner wall of the grill body 1 or extends out from the grill body 1, and the other end of the two second oil guide plates 17 is suspended and inclined downward to be close to the oil pans 4; the waste oil flowing down the inner walls of both left and right sides of the grill body 1 fall into the oil pans 4 below along the second oil guide plates 17; and edges of the second oil guide plates 17 are bent upward to guide the waste oil and prevent the waste oil from leaking, and finally avoid forming waste oil accumulation dead spaces on the left and right sides of the grill body 1.

The oil pan bracket structure is connected to a bottom of the corresponding second oil guide plate 17 by the support 2, that is, the support 2 is detachably connected to a bottom surface of the second oil guide plate 17, such as by a fastener, so that the oil pans 4 and the bracket 3 are detachably connected to a bottom of the grill body 1.

The third oil guide plate 18 is located between two oil pans 4 and is located below the first oil guide plate 16; front and rear ends of the third oil guide plate 18 are connected to the inner wall of the grill body 1 by fasteners; the third oil guide plate 18 is arranged to have a convex middle portion with both sides inclined downward towards the two oil pans 4 respectively, so that the third oil guide plate 18 guides the waste oil into the two oil pans 4 respectively; since the two oil pans 44 are placed side by side, opposite edges of the two oil pans 44 are also arranged side by side; and in order to avoid waste oil on the grilling net 14 from directly dripping onto edges of the oil pans 44, the third oil guide plate 18 is arranged to be convex in the middle, that is, the third oil guide plate is inclined downward towards both sides with the middle as a dividing line, so that the both sides of the third oil guide plate 18 face the corresponding oil pans 44 respectively, so that the waste oil dripping onto the third oil guide plate 18 falls into one of the oil pans 44 along an inclined surface.

Temperature equalizing plates 20 are provided in the grill body 1 between the burner switches 15 and the grilling nets 14, the temperature equalizing plates 20 and the burner switch 15 are arranged in a one-to-one correspondence manner, the temperature equalizing plates 20 are in a curved structure with a convex middle portion and both sides inclined downward, that is to say, a bending direction of the temperature equalizing plate 20 is the same as that of the first oil guide plate 16, an inclined end of the temperature equalizing plate 20 is bent downward to form a vertical bending portion 21, both the bending portion 21 and surfaces of the temperature equalizing plates 20 are provided with a second air hole 22 respectively, and heat released by burners is aggregated under the temperature equalizing plate 20 to form a collection effect; and the second air hole 22 on the surface of the temperature equalizing plate 20 performs secondary diversion on the hot air from the burner from bottom to top, the heat is slowly circulated through the process, forming a three-dimensional circulation in the grill, and the second air hole 22 on the bending portion 21 of the adjacent temperature equalizing plate 20 is aligned, so that the hot air collected by the temperature equalizing plate 20 can pass through the second air hole 22 to reach below the adjacent temperature equalizing plate 20 to form a hot air circulation.

What is claimed is:

1. An oil pan bracket structure, comprising a support, wherein the support is slidably connected to a bracket, the bracket has an oil pan mounted thereon to cause the oil pan to be drawably mounted on the support along with the bracket, and a sliding guide structure is provided between the support and the bracket;
the sliding guide structure comprises a guide groove and a guide post;
the guide groove is arranged on the support and the guide post is arranged on the bracket, or the guide post is arranged on the support and the guide groove is arranged on the bracket; and
the guide groove is arranged along a sliding direction of the bracket to form a guide groove with an elongated structure, and the guide post is placed in the guide groove.

2. The oil pan bracket structure according to claim 1, wherein the guide post is a step screw or a step bolt, and a rod body of the guide post passes through the guide groove and is connected to the bracket.

3. The oil pan bracket structure according to claim 1, wherein the supports are two in number and are respectively located on both sides of the bracket, and opposite side surfaces of the two supports are respectively provided with a supporting surface, and bottoms of the both sides of the bracket contact the supporting surfaces and slide along the supporting surfaces.

4. The oil pan bracket structure according to claim 1, wherein the supports are two in number and are respectively located on the both sides of the bracket, the two supports are respectively provided with a roller, and the both sides of the bracket are respectively provided with guide surfaces in a sliding fit with the rollers.

5. The oil pan bracket structure according to claim 4, wherein a clamping groove is provided on the guide surface, and when the clamping groove slides with the bracket to a preset position, the roller is embedded in the clamping groove to form a limit.

6. The oil pan bracket structure according to claim 2, wherein a side surface of the guide surface is provided with a withdrawal groove communicating with the clamping groove.

7. The oil pan bracket structure according to claim 1, wherein a mounting groove is provided in the center of the bracket, and the oil pan is embedded in the mounting groove.

8. An oil pan bracket structure, comprising:
a support slidably connected to a bracket, the bracket having an oil pan mounted thereon to cause the oil pan to perform a sliding movement along with the bracket on the support; and
a sliding guide structure provided between the support and the bracket to limit the sliding movement of the bracket along a length direction of the support;
wherein when the bracket slides in a first direction so that a distance between a front side portion of the bracket and a front side portion of the support is L1, a first limit portion of the bracket and a second limit portion on the support abut against each other; and
when the bracket slides in a second direction so that the distance between the front side portion of the bracket and the front side portion of the support is L2, a third limit portion of the bracket and a fourth limit portion on the support abut against each other.

9. The oil pan bracket structure according to claim 8, wherein the sliding guide structure comprises a guide groove and a guide post;
the guide groove is arranged on the support, the guide post is arranged on the bracket, the guide post serves as the first limit portion of the bracket, and one end of the guide groove close to the front side portion of the bracket serves as the second limit portion of the support, or the guide post is arranged on the support, the guide groove is arranged on the bracket, the guide post serves as the second limit portion of the bracket, and one end of the guide groove close to the front side portion of the bracket serves as the first limit portion of the bracket; and
the guide groove is arranged along a sliding direction of the bracket to form a guide groove with an elongated structure, and the guide post is placed in the guide groove.

10. The oil pan bracket structure according to claim 9, wherein the guide post is a step screw or a step bolt, and a rod body of the guide post passes through the guide groove and is connected to the bracket.

11. The oil pan bracket structure according to claim 8, wherein the supports are two in number and are respectively located on both sides of the bracket, and opposite side surfaces of the two supports are respectively provided with a supporting surface, and bottoms of the both sides of the bracket contact the supporting surfaces and slide along the supporting surfaces.

12. The oil pan bracket structure according to claim 8, wherein the supports are two in number and are respectively located on the both sides of the bracket, the two supports are respectively provided with a roller, and the both sides of the bracket are respectively provided with guide surfaces in a sliding fit with the rollers.

13. The oil pan bracket structure according to claim 12, wherein a clamping groove is provided on the guide surface, the clamping groove serves as the third limit portion, and the roller serves as the fourth limit portion, and the clamping groove moves with the sliding movement of the bracket so that the roller is embedded in the clamping groove to form a limit.

14. The oil pan bracket structure according to claim 9, wherein a side surface of the guide surface is provided with a withdrawal groove communicating with the clamping groove.

15. The oil pan bracket structure according to claim 1, wherein a mounting groove is provided in the center of the bracket, and the oil pan is embedded in the mounting groove.

16. A grill, comprising a grill body and the oil pan bracket structure according to claim 1, wherein the grill body is provided with grilling nets and burner switches therein, a plurality of the grilling nets are sequentially arranged along an arrangement direction of oil pans, the grill body is provided with a first oil guide plate, two second oil guide plates and a third oil guide plate between the burner switches and the oil pans, and the first oil guide plate is located directly above the oil pan;
the two second oil guide plates are respectively located at both sides of the first oil guide plate, one end of the two second oil guide plates is connected to the grill body, and the other end of the two second oil guide plates is suspended and inclined downward;
the third oil guide plate is located between two oil pans of the oil pan bracket structure and is located below the first oil guide plate, and the third oil guide plate is arranged to have a convex middle portion with both sides inclined downward towards the two oil pans of the oil pan bracket structure respectively; and
each of the supports of the oil pan bracket structure is connected to bottoms of the two second oil guide plates respectively.

17. The grill according to claim 16, wherein the first oil guide plates are multiple in number and are sequentially arranged along the arrangement direction of the oil pans, each of the first oil guide plates is in a curved structure with a convex middle portion and both sides inclined downward, and a first air hole is provided on a surface of the convex middle portion of each of the first oil guide plates.

18. The grill according to claim 17, wherein temperature equalizing plates are provided in the grill body between the burner switches and the grilling nets, the temperature equalizing plates are arranged corresponding to the burner switches, the temperature equalizing plates are in a curved structure with a convex middle portion and both sides inclined downward, an inclined end of the temperature equalizing plate is bent downward to form a vertical bending portion, and the bending portion and a surface of the temperature equalizing plate are both provided with a second air hole.
